(19) United States
(12) Patent Application Publication
(10) Pub. No.: US 2005/0071944 A1
(43) Pub. Date: Apr. 7, 2005

(54) Washing device for motor vehicles

(76) Inventors: Doron Nissim Sherf, Jerusalem (IL); Gil Sagi, Efrat (IL); Ziv Ritchie, Arba (IL)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/482,250

(22) PCT Filed: May 24, 2002
(86) PCT No.: PCT/IL02/00412

(30) Foreign Application Priority Data
May 24, 2001 (IL) 143269
May 22, 2002 (IL) 149797

(51) Int. Cl. A47L 5/38

(52) U.S. Cl. 15/302; 15/385

(57) ABSTRACT

The invention provides a device (10) for detailing contoured motor vehicle surfaces (11), including a cleaning head comprising a) a first chamber (12) having an opening (14) facing the direction of said motor vehicle surface and provided with a motor-driven application means and a treatment substance inlet leading into said chamber (12); b) at least one vacuum chamber at least partially bounded by barrier walls (28) having peripheries adapted to slidingly engage said motor vehicle surfaces (11) while maintaining a partial vacuum (26) there against to assist sliding adherence of said head to said surface, said vacuum chamber (26) being provided with a suction outlet (32) exiting therefrom; and c) a stationary portion (34) including guide means (36) and drive means for said motor driven application means.

The present invention relates to the detailing of vehicle exteriors, wherein the term detailing as used herein is intended to denote washing, waxing and combination thereof.

More particularly, in a first embodiment of the present invention there is provided a powered cleaning device that washes, brushes, dries and collects dirt. The device may be configured to be portable and hand held, or fixed and used as part of an automatic washing installation.

Vehicle washing facilities are known and in use at garages and filling stations. Professional installations include a gantry carrying multiple revolving brushes, and require the vehicle to be cleaned to be positioned adjacent thereto. Longitudinal movement is then effected between the gantry and vehicle; either the gantry or the vehicle is slowly driven to effect the wash.

Portable devices, hand held or otherwise supported are used to wash stationary vehicles and vehicles of unusual size such as aircraft and large trucks. U.S. Pat. Nos. 2,253,609, 3,581,333, 4,135,270 and 5,988,924 describe various devices intended primarily for car washing.

Any vehicle-washing device must take account of the curved shapes and irregular surfaces found on vehicle exteriors. For this reason, devices intended for wall and floor cleaning, for example the apparatuses seen in U.S. Pat. Nos. 3,713,744 and 4,845,794, are unsuitable, being configured for use on flat surfaces only.

A consideration becoming of increasing importance is reducing the quantity of water consumed per vehicle being washed. With rising populations, many countries are short of water, and with increasing pollution of natural sources it is becoming clear that the price of this essential commodity will continue to rise. Furthermore, the number of road vehicles per 1000 people is also rising.

It can thus safely be concluded that further methods of reducing car-wash water consumption will have to be introduced. While much of the water used in fixed installations can be recycled utilizing expensive methods, the water used by prior-art portable devices is totally lost.

Miner, in U.S. Pat. No. 4,135,270 states that by use of his portable car wash apparatus, claimed to be exceedingly economical in water consumption, only 10 gallons (38 liters) of water are required per vehicle. He estimates that an automatic car wash facility consumes 100 gallons (378 liters) of water per vehicle.

It is therefore one of the objects of the present invention to obviate the disadvantages of prior art car washing heads and to provide a device which will effect further substantial water savings.

It is a further object of the present invention to provide a device which reduces water loss by partially adhering itself to vehicle surfaces, including contoured surfaces and to utilized only small amounts of water and detergent for washing the motor vehicle so that recycling is unnecessary.

In another aspect of the present invention there is provided a device for applying wax to the surface of a motor vehicle.

The present invention achieves the above objects by providing a device for detailing contoured motor vehicle surfaces, including a cleaning head comprising: a first chamber having an opening facing the direction of said motor vehicle surface and provided with a motor-driven application means and a treatment substance inlet leading into said chamber; at least one vacuum chamber at least partially bounded by barrier walls having peripheries adapted to slidingly engage said motor vehicle surfaces while maintaining a partial vacuum thereagainst to assist sliding adherence of said head to said surface, said vacuum chamber being provided with a suction outlet exiting therefrom; and a stationary portion including guide means and drive means for said motor driven application means.

In preferred embodiments of the present invention there is provided a device for washing contoured motor vehicle surfaces, including a cleaning head comprising:
a) a first chamber having an opening facing the direction of said motor vehicle surface and provided with a motor-driven cleaning brush and a cleaning substance inlet leading into said chamber;
at least one vacuum chamber at least partially bounded by barrier walls having peripheries adapted to slidingly engage said motor vehicle surfaces while maintaining a partial vacuum thereagainst to assist sliding adherence of said head to said surface, said second chamber being provided with a suction outlet exiting therefrom; and
a stationary portion including guide means and drive means for said motor driven brush.

In some of the preferred embodiments according to the present invention said at least one vacuum chamber is concentrically positioned around said first chamber.

In a preferred embodiment of the present invention there is provided a device for washing motor vehicle surfaces according to the present invention wherein the vacuum chamber is provided with a further brush means for lifting the cleaning substance deposited by the first chamber and entrained dirt from the vehicle surface for removal via the suction outlet.

In preferred embodiments of the present invention there is provided a device for washing motor vehicle surfaces according to the present invention wherein the chambers are shaped as truncated hollow cones, the larger diameters forming the open face arranged to contact the vehicle surface.

In other especially preferred embodiments of the present invention the device comprises a plurality of vacuum chambers and preferably in these embodiments said plurality of vacuum chambers are positioned within said first chamber.

In some preferred embodiments of the present invention the inventive feature of the present invention of providing at least a partial vacuum is achieved by providing tightly packed brush bristles to form said barrier walls.

Yet further embodiments of the invention will be described hereinafter.

It will thus be realized that the novel device of the present invention serves to save water primarily because the vehicle wash fluid is released near the center of the revolving brushes, as opposed to being sprayed on the outer periphery thereof as seen in U.S. Pat. No. 4,135,270 and this also serves to self-clean the brushes.

In the present invention the fluid comes into contact with the vehicle surfaces because there is no other free path. In prior art devices where fluid is sprayed on the outer faces of the revolving brush, centrifugal forces and evaporation causes some of the water to be lost.

The partial vacuum applied to the brushes serves several purposes. It helps to keep the brushes in contact with the vehicle surfaces. The partial vacuum dries the vehicle, and the fluid is collected for possible recycling. The vacuum also removes the fluid/foam with the dirt so that rinse water is not required for the vehicle.

The revolving brush facilitates maintaining motion of the device over the surface of the vehicle being cleaned.

The device can be powered either electrically or pneumatically, each having advantages. Electric operation requires less energy, is quieter, requires less speed reduction, and the trailing cable is lighter and more flexible than an air hose. Pneumatic operation is safer in areas where petrol (gas) is being sold and the motor is not damaged by being stalled by wash water. Whichever motor is used, speed reduction gearing drives the brush at a speed typically of about 30-240 rpm.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

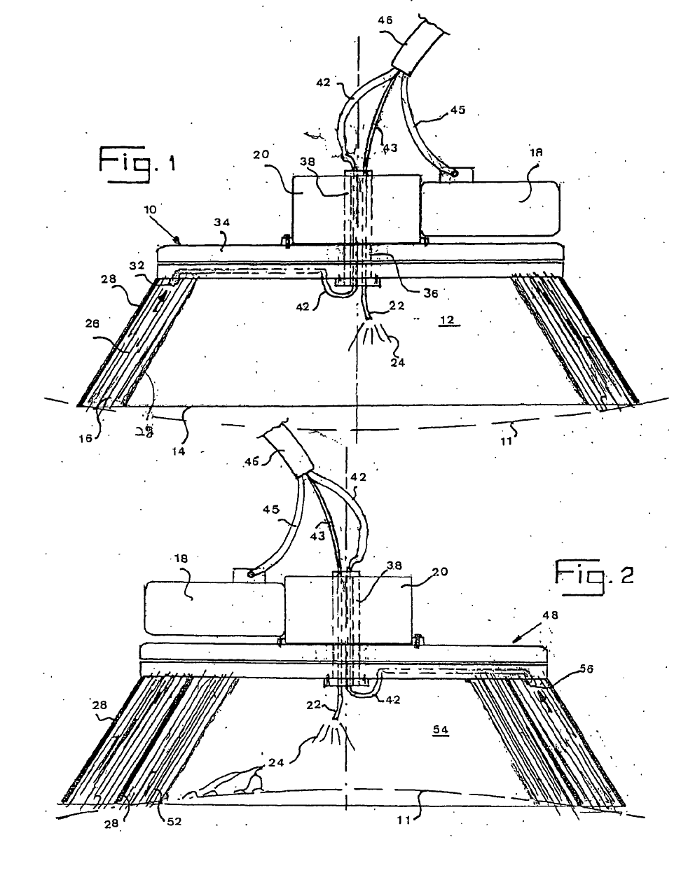

FIG. 1 is an elevational view of a preferred embodiment of the washing device according to the invention;

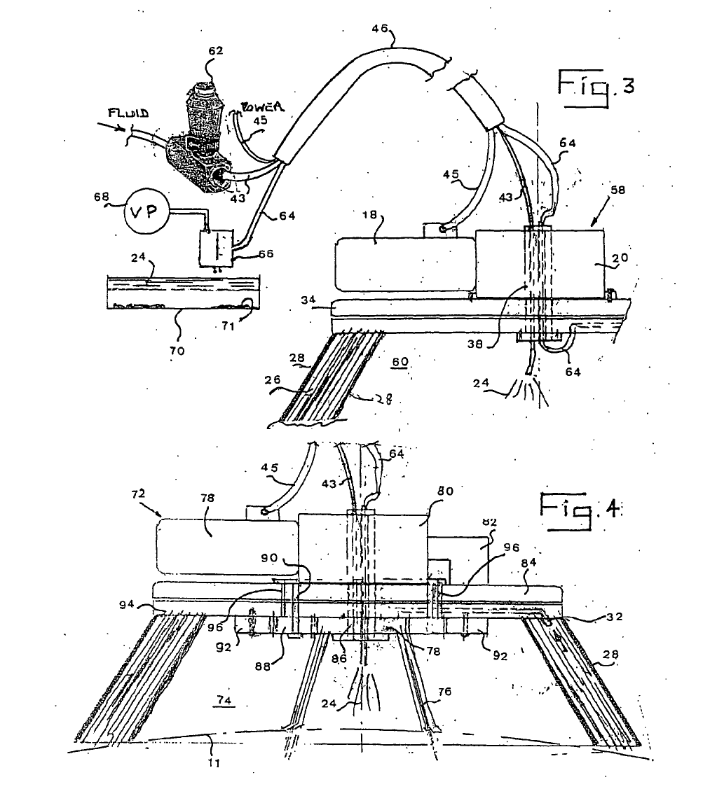

FIG. 2 is an elevational view of an embodiment provided with a further brush for lifting the cleaning substance;

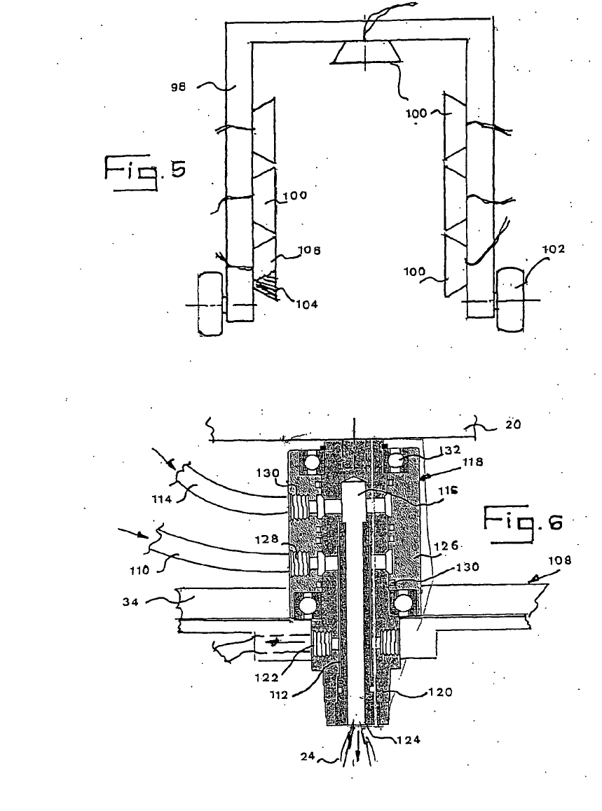

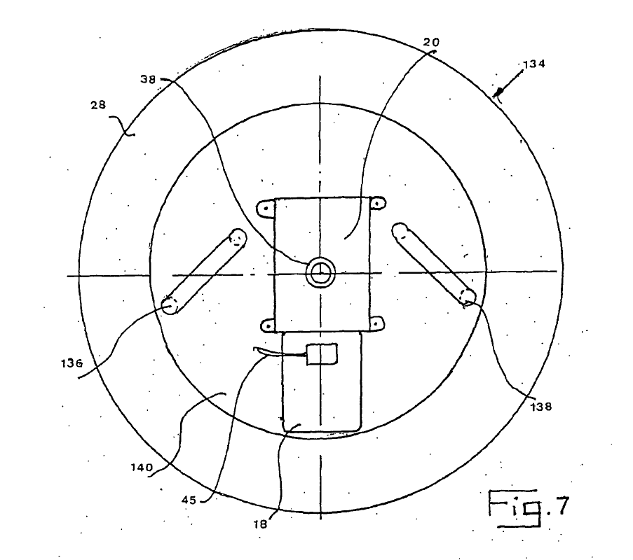

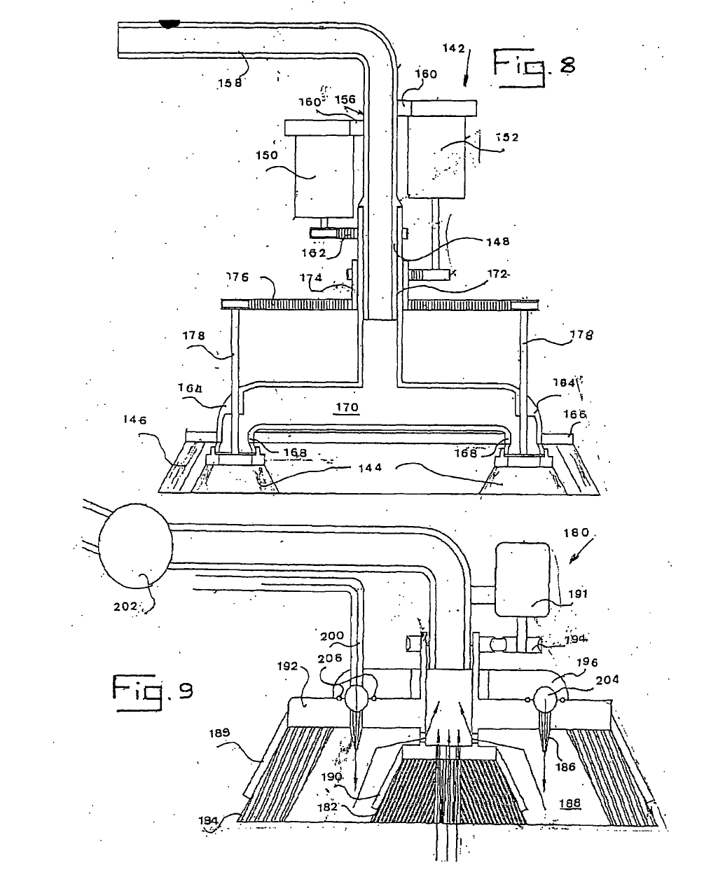

FIG. 3 is a fragmented elevational view of an embodiment including flow control means;

FIG. 4 is a an elevational view of an embodiment provided with a pair of concentric counter-rotating brushes;

FIG. 5 is a diagrammatic view of a car wash gantry carrying a plurality of washer heads;

FIG. 6 is a detail view of means for connecting vacuum and liquid feed lines to the revolving brush;

FIG. 7 is a plan view of a hand-held washer device;

FIG. 8 is an elevational view of an embodiment wherein a plurality of small diameter brushes are driven inside a large diameter brush;

FIG. 9 is an elevational view of second embodiment provided with a pair of concentric brushes; and

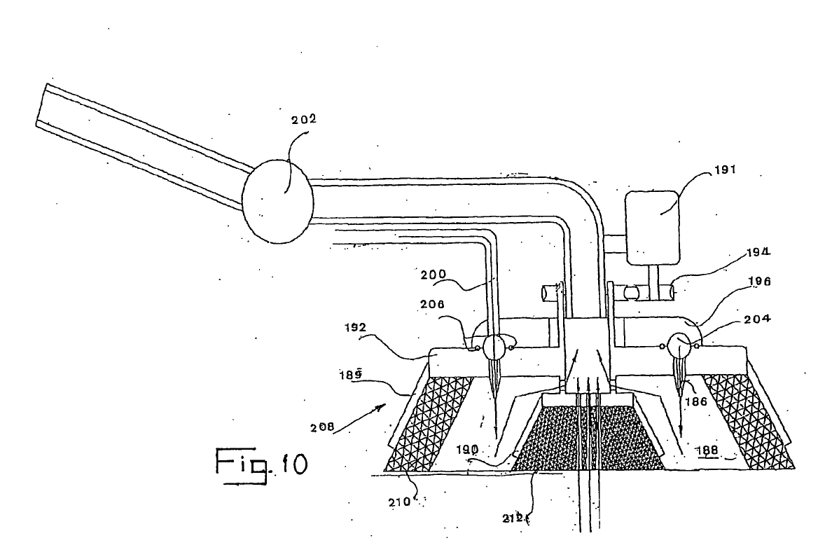

FIG. 10 is an elevational view of an embodiment similar to FIG. 9 provided with a pair of concentric sponges.

There is seen in FIG. 1 a device 10 for washing contoured motor vehicle surfaces 11. In the present embodiment the device 10 is portable and hand held.

The revolving cleaning head comprises a first chamber 12 having an opening 14 of about 30-55 cm diameter facing the direction of the motor vehicle surface.

The cleaning brush 16 is driven by a lightweight motor 18 driving a speed reducer 20. The motor 18 shown is electric. It is alternatively feasible to use a geared pneumatic motor.

Advantageously the cleaning brush 16 is provided with bristles having a coefficient of sliding friction against wet painted metal of less than 0.12, suitably nylon bristles.

A cleaning substance outlet 22 leads into the first chamber 12. Suitably the cleaning substance 24 comprises a mixture of water and/or air and/or a cleaning fluid, or the cleaning substance comprises water carrying a foamed cleaner or can just be a foam or a very foamy water.

A second chamber 26, which is preferably concentrically positioned around the first chamber 12, is bounded by barrier walls 28 having peripheries adapted to slidingly engage the motor vehicle surfaces 11 while maintaining a partial vacuum thereagainst to assist sliding adherence of the head to the surface and to enable the air to enter and vacuum to evacuate the dirty foam and water.

The barrier walls 28 bounding the second chamber are made of an oil-resistant elastomer material, for example a neoprene rubber, nitrile butadiene, or an olefin thermoplastic, the latter material being lightweight and retaining good elasticity even in very cold climates. Wall thickness of the barrier walls 28 bounding the second chamber are about 1-3 mm so that they remain flexible for following and adhering to projections and recesses of the contoured motor vehicle surfaces 11.

The chambers 12, 26 are suitably shaped as truncated cones, the larger diameters forming the open face 14 arranged to contact the vehicle surface 11.

The second chamber 26 is provided with a suction outlet 32 exiting therefrom. A stationary portion 34 including guide means 36 and drive means, a hollow shaft 38 for the motor driven brush is provided. The stationary portion 34 in the present embodiment is adapted to be hand held.

In the present embodiment proximate end forming the suction outlet 32 of the vacuum supply hose 42 revolves with the brush 16 and exits the device through hollow central shaft 38.

The fluid supply hose 43 and the power supply conduit 45 do not rotate.

A further embodiment of hose feed lines will be seen in FIG. 6.

The power (electric in the present embodiment) conduit 45, vacuum hose 42 and fluid hose 43 are advantageously enclosed in a flexible casing 46 to ease manipulation of the device 10.

With regard to the rest of the figures, similar reference numerals have been used to identify similar parts.

Referring now to FIG. 2, there is seen a further embodiment 48 of the device for washing motor vehicle surfaces 11. The second chamber 50 is provided with further brush means 52 for lifting the liquid cleaning substance 24 deposited by the first chamber 54. Thus entrained dirt from the vehicle surface 11 is removed via the suction outlet 56. Since the method uses very little water to start with and the liquid and/or foam is removed by suction of air instead of being rinsed off with water, a minimal amount of water is required per vehicle.

FIG. 3 illustrates part of an embodiment 58 of the device for washing motor vehicle surfaces, further comprising means for limiting the volume of cleaning substance 24 delivered to the first chamber 60 to an amount of less than 3 gallons of fluid per vehicle.

In the present embodiment the device comprises an adjustable fluid flow control valve 62, which can be set to a value of 11.3/t where t is the time in minutes and the valve is marked in units of liters per minute. For example, if the time to wash a vehicle is estimated at 2 minutes, the appropriate flow rate valve setting is 5.6 liters/min.

In locations where water is very scarce the device is suitably arranged so that the volume of cleaning substance 24 delivered to the first chamber 60 is limited to an amount of less than 2 gallons per automobile. Given the same washing time as before, 2 minutes, the appropriate flow rate valve setting is 3.8 liters/min.

The suction hose 64 collects liquid which is removed from the air stream by a simple impingement separator 66, before reaching the vacuum pump 68. The liquid is fed to a filter or settling tank 70 for separating solid dirt from the cleaning fluid 24, allowing reuse thereof. Where such recycling system is in operation, the flow rates stated above can be increased substantially.

A suitable cleaning substance 24 comprises a mixture of water and a commercial vehicle wash detergent, preferably in the form of a foam since foam can be vacuumed more easily than liquid and provides and larger volume for trapping dirt while requiring less water.

Seen in FIG. 4 is a device 72 for washing motor vehicle surfaces 11 wherein the first chamber 74 contains a motor-driven rotary brush 76 for delivery of the cleaning substance 24 and for scrubbing the motor vehicle surface.

The motor 78 is connected to a speed reducer 80 supported by a bracket 82 from the stationary portion 84. A hollow shaft 86 drives the brush 76. A sun gearwheel 78 rigidly attached to the base of the driven brush 76 engages at least one planet gear 88. Planet gear support 90 is fixed to the stationary portion 84 so that the planet gear(s) 88 while free to revolve remains in a fixed position. The planet gear(s) 88 drive(s) an internal ring gear 92 rigidly attached to the outer brush 94, which is then driven in a direction opposed to the direction of the innermost brush. The outer brush 94 is revolvably supported by a large diameter bushing 96, so that the planet gear support(s) 90 can be is fixed to the stationary portion 84, while allowing the brush 94 to revolve.

The gears 78, 88, 92 are suitably, but not necessarily, made of a polymer such as nylon or acetal to reduce weight, to avoid the need for lubrication and to prevent corrosion.

Referring now to FIG. 5, there is depicted in non-detailed form a car wash gantry 98 carrying a plurality of washer devices 100 for washing motor vehicle surfaces.

The devices are mounted as washer heads on a commercial automatic vehicle washer. The gantry 98 of the vehicle washer shown has wheels 102 and holds 7 heads, but can of course be configured to hold more heads or fewer heads.

While the device 100 is similar in principle to the hand-held device, longer brush bristles 104 are used, the barrier walls 106 being lengthened accordingly.

The device 100 is larger and may be heavier than would be suitable for the manually-held device 10 seen in FIG. 1.

FIG. 6 shows a detail of an embodiment 108 of the device for washing motor vehicle surfaces.

Vacuum from a flexible non-revolving vacuum hose 110 is connected to the device 108, and is fed into a revolving chamber 112.

Similarly, the cleaning substance 24 also received by the device 108 from a flexible non-revolving feed hose 114 is transferred to the remaining chamber 116, which also revolves.

In the shown embodiment this is achieved by means of an off-the-shelf twin-path rotary union 118. The union 118 comprises a revolvable inner section 120 having two separate outlets 122, 124 and a non-revolving outer casing 126 provided with two inlets 128, 130. The vacuum hose 110 is connected to one inlet 128, and a cleaning fluid hose 114 is connected to the remaining inlet 130. The union 118 is provided with seals 130 as required to prevent mixing, and with ball bearings 132 for free rotation of the inner section 120.

The union 118 is commercially available, for example from Talco Inc., and no novelty is claimed regarding its design.

FIG. 7 illustrates a further embodiment 134 of the manually-held device for washing motor vehicle surfaces. The device is similar to the device 10 seen in FIG. 1.

Gripping handles 136, 138 for two hands of an operator are rigidly attached to the stationary portion 140. Two-hand operation is advantageous in manipulating the device and in resisting reaction forces generated by the revolving brushes. Alternatively, the unit can be mounted on a rigid, hand-held arm (not shown) and manipulated thereby.

FIG. 8 represents an embodiment 142 wherein a plurality of small diameter brushes 144 are driven inside a large diameter brush 146. The device basically comprises three assemblies:
a) a stationary central bearing 148 assembly, to which geared motors 150 and 152 are rigidly attached;
b) a rotating intermediate assembly, driven by geared motor 150, supporting the small diameter brushes 144 and the large diameter brush 146; and
c) a drive arrangement 154 for rotating the small brushes 144 by means of motor 152.

Assembly a) comprises a stationary structure 156 which includes a suction pipe 158 and supports 160 for both geared motors 150, 152. The stationary assembly is either hand held or attached to a car wash gantry of the type seen in FIG. 5.

The rotating intermediate assembly b) is driven by a toothed belt 162 by geared motor 150. Assembly b) supports the small diameter brushes 144 in bearings 164. The large diameter brush 146 is supported by a disk 166 through which project extensions 168 of a hollow chamber 170. The assembly b) is supported on a bearing 172 provided by the structure 156.

The drive arrangement for rotating the small brushes 144 comprises motor 152, a sleeve 174 driven by motor 152, and a further toothed belt drive 176 which connects the sleeve 174 to the brush shafts 178.

The present embodiment is intended for use where wax, water or other cleaning materials have been previously applied to the vehicle being processed, for example by use of the pipe 158 before suction is applied or by means of a substance outlet 22 as shown in FIGS. 1 and 2 and not shown in the present embodiment.

Referring now to FIG. 9, there is seen a further embodiment 180 provided with an inner 182 and outer 184 hollow conical concentric brush. The device is arranged to supply a cleaning material or wax by means of injectors 186 positioned between the two brushes 182, 184.

Suction is supplied through a flexible tube coupling 202 which is connected to draw air from the space 188 between the two brushes 182, 184. Both brushes are ringed by flexible shrouds 189, 190 made of an elastomer such as rubber. A geared motor 191, electric or pneumatic, drives the brush anchor flange 192 through a toothed belt drive 194. The flange 192 is revolvably supported by a stationary base structure disk 196.

A cleaning material, such as water, foam, wax or the like is supplied through pipe 200 and structure disk 196. A pressure plenum chamber 204 is formed between the disk 196 and the flange 192, seal elements 206 being provided to prevent leakage. The plenum chamber 204 feeds the injectors 186 positioned between the two brushes 182, 184.

Similarly, FIG. 10 shows an embodiment 208 wherein the brushes seen in the previous figure are replaced by sponges 210, 212. All other features are identical to those described with reference to FIG. 9.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A device for detailing contoured motor vehicle surfaces, including a cleaning head comprising:
a) a first chamber having an opening facing the direction of said motor vehicle surface and provided with a motor-driven application means and a treatment substance inlet leading into said chamber;
b) at least one vacuum chamber at least partially bounded by barrier walls having peripheries adapted to slidingly engage said motor vehicle surfaces while maintaining a partial vacuum thereagainst to assist sliding adherence of said head to said surface, said vacuum chamber being provided with a suction outlet exiting therefrom; and
c) a stationary portion including guide means and drive means for said motor driven application means.

2. A device according to claim 1, comprising a plurality of vacuum chambers.

3. A device according to claim 1, for washing contoured motor vehicle surfaces, including a cleaning head comprising:
a) a first chamber having an opening facing the direction of said motor vehicle surface and provided with a motor-driven cleaning brush and a cleaning substance inlet leading into said chamber;
b) at least one vacuum chamber at least partially bounded by barrier walls having peripheries adapted to slidingly engage said motor vehicle surfaces while maintaining a partial vacuum thereagainst to assist sliding adherence of said head to said surface, said second chamber being provided with a suction outlet exiting therefrom; and
c) a stationary portion including guide means and drive means for said motor driven brush.

4. A device for washing motor vehicle surfaces according to claim 3, wherein said at least one vacuum chamber is concentrically positioned around said first chamber.

5. A device for washing motor vehicle surfaces according to claim 3, wherein said chambers are shaped as truncated cones, the larger diameters forming the open face arranged to contact said vehicle surface.

6. A device for washing motor vehicle surfaces according to claim 1, wherein said at least one vacuum chamber is provided with a brush means for lifting a cleaning substance deposited by said first chamber and entrained dirt from said vehicle surface for removal via said suction outlet.

7. A device for washing motor vehicle surfaces according to claim 1, further comprising means for limiting the volume of cleaning substance delivered to said first chamber to an amount of less than 3 gallons of fluid per automobile.

8. A device for washing motor vehicle surfaces according to claim 1, wherein said treatment substance comprises a mixture of water and a commercial vehicle wash detergent, and further includes means for limiting the volume of cleaning substance delivered to said first chamber to an amount of less than 2 gallons per automobile.

9. A device for washing motor vehicle surfaces according to claim 1, wherein said barrier walls bounding said second chamber are made of an elastomer material.

10. A device for washing motor vehicle surfaces according to claim 1, wherein said barrier walls bounding said second chamber are made of rubber.

11. A device for washing motor vehicle surfaces according to claim 1, wherein said first chamber contains a motor-driven rotary brush for delivery of a cleaning substance and for scrubbing said motor vehicle surface.

12. A device for washing motor vehicle surfaces according to claim 11, wherein said motor-driven rotary brush is linked to a gear drive which in turn drives the outer brushes in an opposing direction.

13. A device for washing motor vehicle surfaces according to claim 1, wherein said barrier walls bounding said second chamber are flexible for following and adhering to projections and recesses of said contoured motor vehicle surfaces.

14. A device for washing motor vehicle surfaces according to claim 3, wherein said cleaning brush of said first chamber is provided with bristles having a coefficient of sliding friction against wet painted metal of less than 0.12 and are driven at a peripheral speed of at least 200 meters/minute.

15. A device for washing motor vehicle surfaces according to claim 1, wherein said device is portable and hand held.

16. A device for washing motor vehicle surfaces according to claim 1, wherein said device is mounted as a head on a commercial automatic vehicle washer.

17. A device for washing motor vehicle surfaces according to claim 3, wherein said cleaning substance comprises a mixture of water and a cleaning fluid.

18. A device for washing motor vehicle surfaces according to claim 1, wherein said treatment substance is a cleaning substance comprises water carrying a foamed cleaner.

19. A device for washing motor vehicle surfaces according to claim 1, wherein said treatment substance is a foam.

20. A device for washing motor vehicle surfaces according to claim 3, wherein vacuum is transferred from a feed hose to one of said chambers and said cleaning substance is transferred to the remaining said chamber by means of a twin-path rotary union.

21. A device for washing motor vehicle surfaces according to claim 15, further including gripping means for two hands of an operator, attached to said stationary portion.

22. A device for washing motor vehicle surfaces according to claim 1, wherein said treatment substance is a wax.

23. A device according to claim 2, wherein said plurality of vacuum chambers are positioned within said first chamber.
